(19) United States
(12) Patent Application Publication
(10) Pub. No.: US 2021/0252891 A1
(43) Pub. Date: Aug. 19, 2021

(54) Time Keeping Marking Device

(71) Applicant: Tiffany Windley, Evanston, WY (US)

(72) Inventor: Tiffany Windley, Evanston, WY (US)

(21) Appl. No.: 16/789,566

(22) Filed: Feb. 13, 2020

(51) Int. Cl. B41K 1/40; C09D 11/50

(52) U.S. Cl. CPC B41K 1/40; C09D 11/50

(57) ABSTRACT

A time keeping marking device is shown and described. The time keeping marking device includes a housing having an interior volume. A first end of the housing has a stamping device affixed thereto. The stamping device is fluidly connected to a reservoir. The reservoir houses a time dissipating ink. The ink is made from at least a coloring agent, a bonding agent, and a chemical compound that allows the ink to dissipate over time. A second end of the housing has an aperture therethrough, wherein the aperture accepts an attachment device.

### BACKGROUND OF THE INVENTION

The present invention relates to a time keeping marking device. More particularly, the present invention provides a visible stamp that will slowly dissipate at a rate similar to sunscreen in order to keep time.

Many individuals enjoy being out in nice weather. In such weather sun burn often occurs. Sunscreen is often applied in order to attempt to prevent sun burn. Unfortunately, this is not always effective. Sunscreen must be reapplied in order to remain effective.

Trying to keep track of sunscreen applications is difficult, especially when applying sunscreen to multiple people throughout the day. Parents often forget the last time they applied sunscreen to their children and either end up reapplying too soon or letting too much time go by between applications. This means that not only is the parents relaxation interrupted but the child may become burnt despite the parent's best efforts.

In some instances, sunscreen may need reapplied sooner than recommended. Some of these conditions include when a person is swimming or exercising. The added moisture will cause sunscreen to dissipate at different rates. This can be even more difficult to calculate due to the different chemicals in bodies of water. Further, many times when individuals are busy with other things, they forget to apply more sunscreen.

Consequently, there is a need in for an improvement in the art of time keeping. The present invention substantially diverges in design elements from the known art while at the same time solves a problem many people face when attempting to keep time when in a sun filled environment. In this regard the present invention substantially fulfills these needs.

### SUMMARY OF THE INVENTION

The present invention provides a time keeping marking device wherein the same can be utilized for providing convenience for the user when needing to keep time without a watch or clock present. The time keeping marking device is comprised of a housing having an interior volume. A first end of the housing has a stamping device affixed thereto. The stamping device is fluidly connected to a reservoir. The reservoir houses a time dissipating ink. A second end of the housing has an aperture therethrough, wherein the aperture is configured to accept an attachment device.

Another object of the present invention is to have a lid configured to connect to the first end around the stamping device.

Another object of the present invention is to have the housing be a cylindrical housing.

Another object of the present invention is to have the stamp is be sun shape.

Another object of the present invention is to have the stamp be a logo representing a company.

Another object of the present invention is to have a holster to secure the marking device to a bottle.

Another object of the present invention is to have a length of cord secured within the aperture.

Another object of the present invention is to have a carabiner secured within the aperture.

Another object of the present invention is a time keeping marking ink comprised of a coloring agent, a bonding agent, and a chemical compound that allows the ink to dissipate over time.

Another object of the present invention is to have the ink dissipate at a rate similar to sunscreen.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the time keeping marking device.

FIG. 2 shows a cross-sectional view of an embodiment of the time keeping marking device.

FIG. 3A shows a perspective view of an embodiment of the tip of the time keeping marking device with a sun.

FIG. 3B shows a perspective view of an embodiment of the tip of the time keeping marking device with a smiley face.

FIG. 3C shows a perspective view of an embodiment of the tip of the time keeping marking device to represent a logo.

FIG. 4 shows as perspective view of an embodiment of the time keeping marking device with a connector.

FIG. 5 shows as perspective view of an embodiment of the time keeping marking device with a bottle holster.

### DETAILED DESCRIPTION OF THE INVENTION

Reference is made herein to the attached drawings. Like reference numerals are used throughout the drawings to depict like or similar elements of the time keeping marking device. For the purposes of presenting a brief and clear description of the present invention, a preferred embodiment will be discussed as used for the time keeping marking device. The figures are intended for representative purposes only and should not be considered to be limiting in any respect.

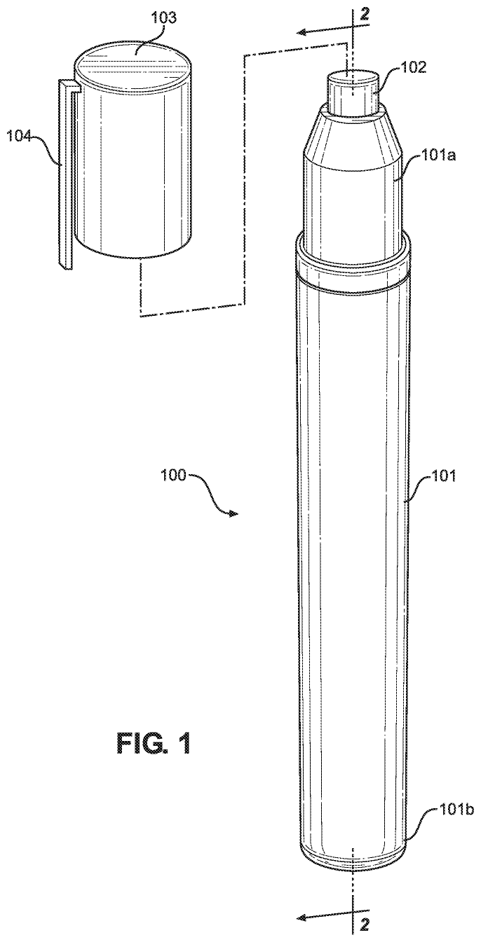

Referring now to FIG. 1, there is shown a perspective view of an embodiment of the time keeping marking device. The time keeping marking device 100 is comprised of a housing 101. The housing has a first end 101a and a second end 101b. The housing 101 has an interior volume and an opening at the first end 101a. The second end 101b of the housing is a closed end. In one embodiment the housing is a cylindrical housing. In another embodiment the housing has a rectangular cross-section. In yet a further embodiment the housing is triangular. In one embodiment the housing is made from plastic. In another embodiment the housing is made from a composite material.

The first end 101a of the housing 101 is configured to accept a marking tip 102 therein. In one embodiment the marking tip 102 is a felt tip. In another embodiment the marking tip 102 is made from rubber. The marking tip 102 is configured to protrude from the open first end 101a. This will allow the marking tip 102 to function as a stamp.

In one embodiment the first end 101a of the housing 101 is configured to accept a cap 103 thereon. In one embodiment the cap 103 has a clip 104 located along a side of the cap 103. In one embodiment the cap 103 is configured to frictionally attach to the first end 101a of the housing 101. In one embodiment the first end 101a of the housing 101 tapers inward to fit within the cap 103. In another embodiment the cap 103 is proportioned to be larger than the housing 101. In on embodiment the cap 103 is configured to have a snap fit with the housing 101. In this embodiment the cap 103 has an indent disposed on an interior surface thereof and the housing 101 has a raised section. The raised section of the housing 101 will fit into the indent.

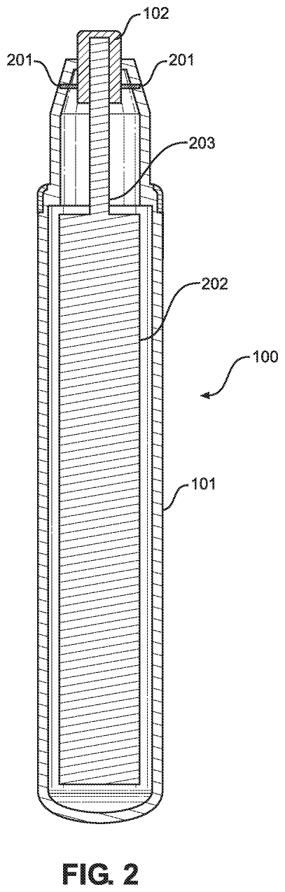

Referring now to FIG. 2, there is shown a cross-sectional view of an embodiment of the time keeping marking device. In the shown drawing the housing 101 is in the cylindrical configuration. From this view it is shown that the marking tip 102 is held in place with a plurality of pins 201. The plurality of pins 201 only enter partially into the marking tip 102. This will prevent the pins from entering the channel 203.

There is a reservoir 202 located within the housing 101. In one embodiment the reservoir 202 is configured fill the interior volume. In another embodiment the reservoir 202 is configured to only take up part of the interior volume. In one embodiment the reservoir 202 is configured to hold pressure. This will allow for ink to be under slight pressure for a better application. In one embodiment the reservoir 202 is made from plastic. The reservoir 202 is configured to hold ink.

The reservoir 202 is fluidly connected to the marking tip 102. In one embodiment the marking tip 102 is directly connected to the reservoir 202. In another embodiment the marking tip is connected to the reservoir 202 via a channel 203. The connection will allow ink from within the reservoir 202 to flow to the marking tip 102. This will allow for a small amount to populate the end of the marking tip 102. The ink can then be transferred from the reservoir 202 through the marking tip 102 onto a desired surface.

The ink is comprised of an adhesive agent and a coloring agent. In one embodiment the coloring agent is blue. In another embodiment the coloring agent is white. In yet a further embodiment the coloring agent is another color that stands out. In one embodiment the ink is further comprised of agents that will allow the ink to dissipate. In many embodiments the ink will be configured to disappear at the same rate as sunscreen. In further embodiments the ink will dissipate at the same rate as sunscreen in water. This will allow the time keeping marking device 100 to mark a user. When the ink dissipates the wearer will know it is time to reapply sunsc en.

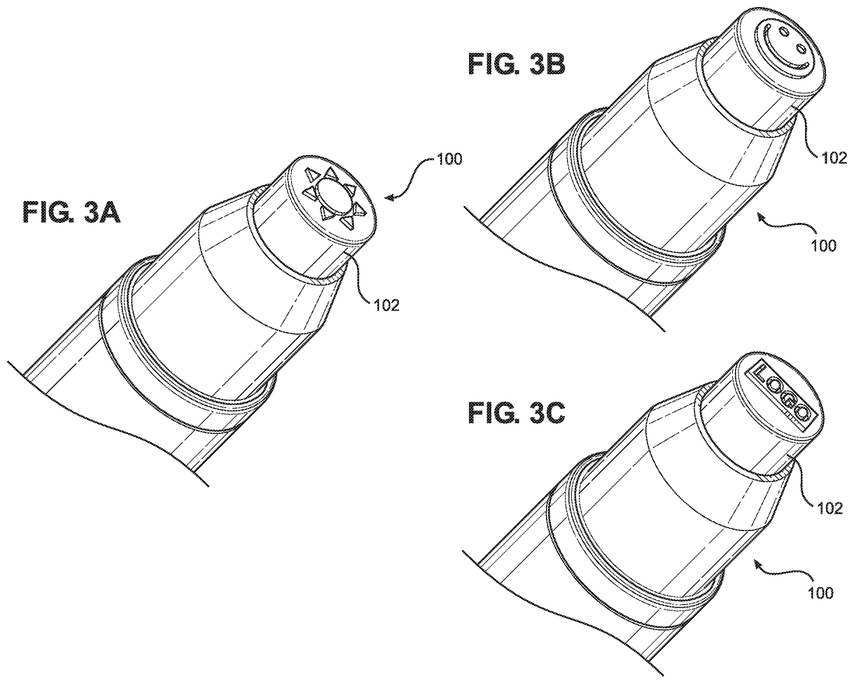

Referring now to FIG. 3A, FIG. 3B, and FIG. 3C, there is shown a perspective view of an embodiment of the tip of the time keeping marking device with a sun. In one embodiment the marking tip 102 is configured to leave a sun shaped stamp. The sun shaped stamp is fitting due to the nature of the device to remind a wearer to apply sunscreen. In another embodiment the marking tip 102 is a smiley face. In other embodiments other generic stamps may be used. In yet another embodiment the stamps may represent the type of ink stored within the time keeping marking device 100. In another embodiment the stamp may represent a company. In this embodiment the stamp may be a trademark or other representative marking.

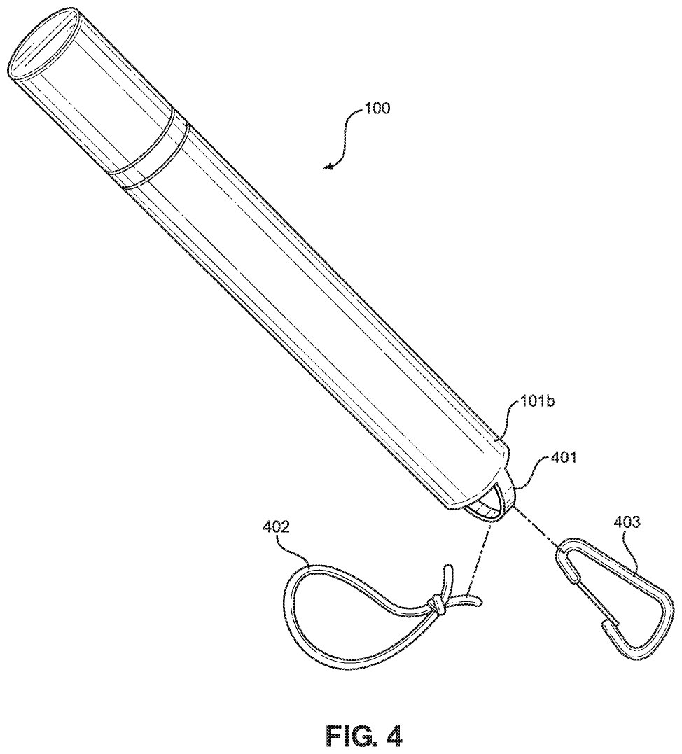

Referring now to FIG. 4, there is shown as perspective view of an embodiment of the time keeping marking device with a connector. In some embodiments the time keeping marking device 100 has an aperture 401 located on a rear end 101b of the housing. The aperture 401 is configured to accept an attachment device therein. In one embodiment the attachment device is a cord 402. In another embodiment the attachment device is a carabiner 403. The aperture 401 will have the attachment device placed therein. The attachment device will then be able to secure the time keeping marking device 100 to an article of clothing or other suitable location. In one embodiment the aperture 401 is defined by a shatter resistant material.

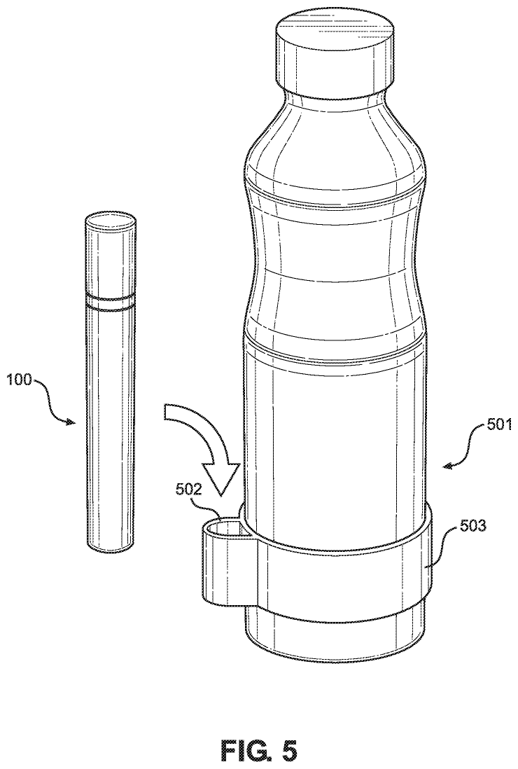

Referring now to FIG. 5, there is shown as perspective view of an embodiment of the time keeping marking device with a bottle holster. In one embodiment the time keeping marking device 100 is configured to fit within a holster 501. The holster is comprised of a slot 502 for the time keeping marking device 100 and a belt 503. In one embodiment the slot 502 is made from a high friction material. This will prevent the time keeping marking device 100 from unwantedly falling from the slot 502. The belt 503 is configured to be removably secured to a bottle or other item. This will help a user be able to remember to use the time keeping marking device 100 after applying sunscreen.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A time keeping marking device, the device comprising:
a housing;
a first end of the housing has a stamping device affixed thereto;
the stamping device is fluidly connected to a reservoir;
the reservoir houses a time dissipating ink.

2) The time keeping marking device of claim 1, further comprising a lid configured to connect to the first end around the stamping device.

3) The time keeping marking device of claim 1, wherein the housing is a cylindrical housing.

4) The time keeping marking device of claim 1, wherein the stamp is a sun shape.

5) The time keeping marking device of claim 1, wherein the stamp is a logo representing a company.

6) The time keeping marking device of claim 1, further comprising a holster to secure the marking device to a bottle;
the holster is comprised of a belt configured to secure around a bottle;
the belt has a slot attached there to, wherein the slot is configured to accept the marking device.

7) A time keeping marking device, the device comprising:
a housing having an interior volume;
a first end of the housing has a stamping device affixed thereto;
the stamping device is fluidly connected to a reservoir;
the reservoir houses a time dissipating ink;
a second end of the housing has an aperture therethrough, wherein the aperture is configured to accept an attachment device.

8) The time keeping marking device of claim 7, further comprising a lid configured to connect to the first end around the stamping device.

9) The time keeping marking device of claim 7, wherein the housing is a cylindrical housing.

10) The time keeping marking device of claim 7, wherein the stamp is a sun shape.

11) The time keeping marking device of claim 7, wherein the stamp is a logo representing a company.

12) The time keeping marking device of claim 7, further comprising a holster to secure the marking device to a bottle.

13) The time keeping marking device of claim 7, further comprising a length of cord secured within the aperture.

14) The time keeping marking device of claim 7, further comprising a carabiner secured within the aperture.

15) A time keeping marking ink, the ink comprising:
a coloring agent;
a bonding agent; and
a chemical compound configured to dissipate over time.

16) The time keeping marking ink of claim 15, wherein the ink will dissipate at a rate similar to sunscreen.
